(19) United States
(12) Patent Application Publication
(10) Pub. No.: US 2023/0374682 A1
(43) Pub. Date: Nov. 23, 2023

(54) OPERATING AN ELECTROLYSIS DEVICE

(71) Applicant: Siemens Energy Global GmbH & Co. KG, Munich, Bayern (DE)

(72) Inventor: Peter Utz, Nurnberg (DE)

(73) Assignee: Siemens Energy Global GmbH & Co. KG, Munich, Bayern (DE)

(21) Appl. No.: 18/030,852

(22) PCT Filed: Aug. 9, 2021
(86) PCT No.: PCT/EP2021/072117

§ 371 Date: Apr. 7, 2023

(30) Foreign Application Priority Data
Oct. 12, 2020 (EP) 20201333

(51) Int. Cl. C25B 15/06; C25B 15/023; C25B 1/34; C25B 9/65

(52) U.S. Cl. CPC C25B 15/06; C25B 15/023; C25B 1/34; C25B 9/65

(57) ABSTRACT

An electrolysis device having at least one electrolytic cell and an electrolysis energy source connected to the at least one electrolytic cell. A method for operating an electrolysis device includes applying an electrical electrolysis current to at least one electrolytic cell of the electrolysis device during normal operation in order to perform electrolysis of a substance located in a reaction chamber of the electrolytic cell, and detecting the electrical electrolysis current by a sensor unit. A protective voltage is applied to at least one electrolytic cell according to the detected electrical electrolysis current, which protective voltage is provided individually for the at least one electrolytic cell.

### CROSS REFERENCE TO RELATED APPLICATIONS

This application is the US National Stage of International Application No. PCT/EP2021/072117 filed 9 Aug. 2021, and claims the benefit thereof. The International Application claims the benefit of European Application No. EP20201333 filed 12 Oct. 2020. All of the applications are incorporated by reference herein in their entirety.

### FIELD OF INVENTION

The invention relates to a circuit arrangement for at least one electrolytic cell of an electrolysis device, having an electrical auxiliary voltage source which is used to provide an electrical auxiliary DC voltage, and connection contacts for electrical connection to cell connections of the at least one electrolytic cell. The invention also relates to an electrolysis device having at least one electrolytic cell and an electrolysis energy source connected to the at least one electrolytic cell. Finally, the invention also relates to a method for operating an electrolysis device, wherein an electrical electrolysis current is applied to at least one electrolytic cell of the electrolysis device during intended operation in order to electrolyze a substance arranged in a reaction chamber of the electrolytic cell, and wherein the electrical electrolysis current is captured by means of a sensor unit.

### BACKGROUND OF INVENTION

Electrolysis devices, in particular for electrolyzing water to form hydrogen and oxygen, are extensively known in the prior art, for example from DE 197 29 429 C1. The basic function of electrolysis, in particular water electrolysis, is known to a person skilled in the art, which is why no detailed explanations of it are provided.

Electrolysis devices which have an individual electrolytic cell, but in particular a multiplicity of electrolytic cells which are generally at least partially electrically connected in series, are used, in particular, to produce substances which can preferably be used on an industrial scale, for example hydrogen in the case of water electrolysis, carbon monoxide in the case of carbon dioxide electrolysis or the like. For this purpose, a suitable small electrical DC voltage, which may be in the range of a few volts or possibly even less than 1 V, is applied to at least two electrodes of a respective electrolytic cell. In accordance with the amount of substance to be provided by the electrolysis, the electrolysis energy source provides a corresponding electrical direct current as the electrolysis current. In the case of electrolytic cells connected in series, this direct current flows through all of the battery cells connected in series. The series circuit is electrically connected to the electrolysis energy source. However, a parallel circuit of electrolytic cells may also be at least sometimes basically provided.

In particular, in the case of aqueous electrolysis processes, for example chlorine-alkali electrolysis processes, PEM electrolysis processes or the like, a membrane is generally provided and separates respective reaction chambers, in which respective electrodes are arranged, in a reaction zone of a respective electrolytic cell. In addition, a catalyst is often arranged on a respective membrane in order to enable or accelerate the electrolysis process. The electrolysis is achieved by virtue of a suitable electrical electrolysis current and a suitable electrical DC voltage or cell voltage being applied to the electrodes of a respective electrolytic cell during intended operation.

In this case, it proves to be problematic if an electrolysis energy source providing the cell voltage or the electrolysis current is not active because, for example, it is switched off, there is a fault or the like. This may result in undesirable processes being able to occur in a respective electrolytic cell in which the electrolysis is carried out in the reaction zone in which the electrodes and the membrane are also arranged. For example, on account of residual gases, in particular during water electrolysis, there is the risk of the polarity of the electrical voltage or cell voltage being inverted at cell connections of the electrolytic cell in comparison with intended operation, and the result may be a reaction in the manner of a fuel cell in the electrolytic cell. This may result in severe aging of the electrolytic cell, in particular of the membrane.

In the prior art, the above-mentioned problem is reduced by connecting a further auxiliary energy source in a parallel connection to the series circuit in parallel with the electrolysis energy source. The auxiliary energy source does not need to provide a high power in this case, but rather provides only a considerably lower defined protective current which flows through the electrolytic cells connected in series. In this case, the protective current is such that a sufficient electrical voltage, which avoids the above-mentioned problems, is achieved at the respective cell connections for all of the electrolytic cells connected in series.

If the electrolysis energy source and the auxiliary energy source are supplied by an energy supply network with electrical energy which uses an AC voltage, the electrolysis energy source may be formed by a rectifier which can also be referred to as a main rectifier. The auxiliary energy source may likewise be formed by a suitable rectifier which can also be referred to as a polarization rectifier.

However, the above-mentioned use of the auxiliary energy source has the disadvantageous effect that the electrolysis substances are still produced—albeit in small quantities under certain circumstances—inter alia when the electrolysis device is switched off. Further continuous gas production may be the result here with respect to water electrolysis or carbon dioxide electrolysis.

In the prior art, the design of the electrolysis device is not operationally optimized for this use. Therefore, this may result in undefined operating states which, in the worst case scenario, can even result in the production of a ignitable gas mixture. In the prior art, it is therefore still necessary to provide additional protective measures in order to avoid dangerous operating states of the electrolysis device or of the respective electrolytic cells, especially outside intended electrolysis operation.

### SUMMARY OF INVENTION

The invention is therefore based on the object of improving the safety of an electrolysis device or an electrolytic cell and the operation thereof, in particular outside intended electrolysis operation.

As a solution, the invention proposes a circuit arrangement, an electrolysis device and a method according to the independent claims.

Advantageous developments emerge from features of the dependent claims.

With regard to a circuit arrangement of the generic type, the invention proposes, in particular, that the circuit arrangement has a protective voltage unit which is electrically coupled to the electrical auxiliary voltage source and is designed to provide an individual protective voltage for the at least one electrolytic cell, and a switching unit which is connected to the protective voltage unit and to the connection contacts and is designed to electrically couple the protective voltage unit for providing the protective voltage at the connection contacts to the connection contacts depending on a switching state of the switching unit.

With regard to an electrolysis device of the generic type, the invention proposes, in particular, that it has a circuit arrangement according to the invention which is connected to the at least one electrolytic cell.

With regard to a method of the generic type, the invention proposes, in particular, that a protective voltage, which is individually provided for the at least one electrolytic cell, is applied to the at least one electrolytic cell depending on the captured electrical electrolysis current.

The invention is based, inter alia, on the concept that the safety of the electrolysis device, in particular of the at least one electrolytic cell, can be considerably improved outside intended electrolysis operation if it is possible to provide, for each electrolytic cell, an individual protective voltage which has been selected to be sufficiently high to avoid the dangerous states mentioned at the outset, but at the same time has been selected such that an electrolytic effect will substantially not yet be provided. This makes it possible, even in the case of a multiplicity of electrolytic cells of an electrolysis device, to react to specific properties of a respective electrolytic cell in a targeted and individual manner and therefore to be able to provide a reliable safe operating state outside the intended electrolysis functionality. The problems of the prior art mentioned at the outset can thereby be largely avoided, but at least reduced.

The protective voltage unit may be individually adjustable for each of the electrolytic cells, with the result that a respective individual protective voltage can be provided for each of the electrolytic cells of an electrolysis device. In a particularly advantageous manner, provision may be made for the individual protective voltage to be able to be individually adjusted for a respective electrolytic cell. Naturally, provision may also be made for a common protective voltage unit to be provided for a plurality of electrolytic cells and to be connected to the corresponding cell connections of these electrolytic cells, with the result that an individual protective voltage can be provided for each of the electrolytic cells. Combinations thereof may also naturally be provided.

As a result of the fact that the protective voltage unit can be used to provide a protective voltage, it is also possible at the same time to achieve the situation in which a current flow through the respective electrolytic cell needs to be only very small, with the result that, on the one hand, the auxiliary voltage source needs to be designed only for a very small fraction of the power of the electrolysis energy source and, on the other hand, production of electrolysis products, in particular gases, can be substantially reduced. In particular, a cell current of the at least one electrolytic cell may be substantially zero. This allows the risks occurring in the prior art to be largely avoided. In addition, the undefined states which occur in the prior art with respect to the process technology may also be largely avoided. Finally, the appraisal of the risk consideration may also be considerably reduced, in particular with respect to a HAZOP method (Hazard and Operability) or PAAG method (Prognose, Auffinden, Abschätzen, Gegenmaßnahmen [prediction, detection, estimation, countermeasures]).

The protective voltage unit is preferably an electronic circuit or a hardware circuit which is supplied with electrical energy by the auxiliary voltage source. The electrical voltage of the auxiliary voltage source is preferably applied to the electronic circuit such that it consequently accordingly provides the respective protective voltage. This circuit arrangement is preferably individually provided for each electrolytic cell. However, provision may also be made for the electronic circuit to be designed for two or more electrolytic cells. The protective voltage may be selected in a range from approximately 1.35 V to approximately 1.45 V for electrolysis of water, for example. During intended electrolysis operation, the operating voltage is generally greater than the protective voltage. During intended electrolysis operation, the operating voltage at a respective electrolytic cell may be approximately 1.9 V during the electrolysis of water. Under certain circumstances, this voltage may also be approximately 1.8 V as a result of suitable electrolytes and/or catalysts. However, these values are dependent on the respective specific applications and the substances to be electrolyzed. During the electrolysis of carbon dioxide or another substance, these values may naturally be different.

The switching unit is used to electrically couple the protective voltage unit to the connection contacts only when the at least one electrolytic cell or the electrolysis device is not in intended electrolysis operation. This makes it possible to largely avoid undesirable interactions during intended electrolysis operation. For this purpose, the switching unit may have electromechanical switching elements or electronic switching elements.

The electromechanical switching element may be formed, for example, by a relay, a contactor, a reed contact and/or the like.

An electronic switching element, in particular a semiconductor switch or a semiconductor switching element which is operated in the switching mode can also be used to provide the desired switching functionality. Such a semiconductor switching element may be, for example, a transistor in the switching mode, a thyristor or the like. With respect to a semiconductor switching element using a transistor, the switching mode means that a very small electrical resistance is provided between the connections of the transistor which form a switching path in a switched-on switching state, with the result that a high current flow is possible in the case of a very small residual voltage. In contrast, in a switched-off switching state, the switching path of the transistor has a high impedance, that is to say it provides a high electrical resistance, with the result that there is substantially no or only a very small, in particular negligible, current flow even when a high electrical voltage is applied to the switching path. A linear mode of transistors differs from this.

Basically, not all connection contacts need to be connected by means of a switching element of the switching unit. In order to be able to interrupt the provision of the protective voltage at a respective electrolytic cell, it already suffices to connect only one of the connection contacts via a switching element for the respective electrolytic cell. However, if electrolytic cells are connected in series, it is expedient to preferably connect all of the connection contacts via switching elements. In this case, it also proves to be particularly advantageous that DC isolation of the protective voltage unit from the electrolytic cells can be achieved here.

The switching elements of the switching unit are preferably switched together. For this purpose, the switching unit may have an accordingly suitable control circuit. The control unit may be designed to implement the respective switching state of the switching unit by means of a suitable control signal. Basically, it is also possible for the control circuit to be designed to be actuated manually in order to be to assume the respective switching state. Combinations thereof may also be provided.

It is also proposed that the protective voltage unit for providing the protective voltage has an electronic voltage converter electrically coupled to the electrical auxiliary voltage source. This makes it possible to convert the electrical voltage provided by the auxiliary voltage source to the protective voltage, with the result that the respective individual protective voltage can be reliably provided for the respective electrolytic cell.

The electronic voltage converter may be designed, for example, as a clocked energy converter in the form of a DC/DC converter or the like. In addition, the voltage converter may naturally also have only passive electronic components in order to be able to provide the respective individual protective voltage for the respective electrolytic cell. Combinations thereof may also be provided.

The voltage converter is preferably in the form of an in-phase regulator. The in-phase regulator can be used to regulate or adjust the protective voltage for the at least one electrolytic cell, preferably for a respective one of the electrolytic cells, in a particularly fast and reliable and stable manner. A separate in-phase regulator is preferably provided for each electrolytic cell. This makes it possible to adjust the protective voltage in a particularly simple manner. The in-phase regulators are preferably adjustable, to be precise particularly preferably adjustable by means of the control circuit. This makes it possible to be able to individually adjust all in-phase regulators via a central controller in order to be able to individually provide the respective protective voltage. In addition, it is naturally possible to implement additional functionalities, for example to individually react to state changes of respective electrolytic cells that can be captured by means of suitable sensors or sensor units and that can capture, for example, gas production, a temperature or the like. The respective in-phase regulators can then be appropriately adjusted depending on these sensor signals.

The in-phase regulator also has the advantage that the protective voltage can be kept constant in a wide range substantially independently of the electrical current applied thereto.

In addition, it is proposed that the voltage converter has at least one diode and/or at least one electrical resistor which is used to provide the protective voltage. For example, provision may be made for the protective voltage to be directly provided via an individual diode or a plurality of diodes which are connected in series and to which a corresponding electrical current is applied. Basically, this possibility naturally also exists with an electrical resistor. That is to say, the respective protective voltage can be directly tapped off at the diode or at the series circuit of the diodes or at the electrical resistor and can be supplied to the respective connection contacts. The protective voltage can be adjusted by adjusting the respective current of the diode or of the resistor. A diode or an electrical resistor or a series circuit of diodes is preferably provided for each electrolytic cell. The diode may basically also be a Zener diode.

In addition, it is proposed that the circuit arrangement has a sensor unit which is connected at least to the switching unit and is designed to capture an electrolysis current or a cell current of the at least one electrolytic cell and to transmit a corresponding sensor signal at least to the switching unit. In addition, the sensor signal may also be transmitted to the control circuit of the switching unit. On the basis of the sensor signal, an operating state of the electrolysis device or of the electrolytic cells can be determined, to be precise in particular electrolysis operation or a disrupted operating state or a switched-off operating state. The switching unit and the protective voltage unit can then be operated depending on the operating state determined thereby. Basically, provision may also naturally be made for the switching unit or the circuit arrangement to have a communication interface which can be used to adjust appropriate functions and to query adjustments of the circuit arrangement, in particular of the switching unit and of the protective voltage unit. This is advantageous for automating the control of the circuit arrangement or of the electrolysis device.

With respect to the electrolysis device, it is also proposed that it has a control unit which is designed to capture an operating state of the electrolysis energy source and to transmit a state signal to the circuit arrangement depending on the captured operating state, wherein the circuit arrangement is designed to provide a protective voltage for the at least one electrolytic cell depending on the state signal. This makes it possible to capture the operating state of the electrolysis energy source in an automated manner and to suitably control the operation of the circuit arrangement by means of the state signal in order to be able to also largely avoid dangerous states outside intended electrolysis operation. The state signal may be transmitted, for example, to the control circuit of the circuit arrangement or of the switching unit which accordingly evaluates this state signal.

In addition, provision may be made for the electrolysis device to have an isolating unit which is designed to electrically isolate the electrolysis energy source from the at least one electrolytic cell depending on a switching state of the isolating unit. This development has the advantage that interactions between the circuit arrangement and the electrolysis energy source can be largely avoided. If the electrolysis energy source is specifically in a disrupted operating state which implements an electrical short circuit, for example, the isolating unit may be used to nevertheless apply the desired protective voltages to the respective electrolytic cells by means of the circuit arrangement of the invention. The safety of the electrolysis devices can thereby be improved further.

The advantages stated for the circuit arrangement according to the invention likewise naturally also apply to the electrolysis device according to the invention and to the method according to the invention, and vice versa. In this respect, device features may also be formulated as method features, and vice versa.

The exemplary embodiments explained below are preferred embodiments of the invention. The features and combinations of features stated above in the description and the features and combinations of features mentioned in the following description of exemplary embodiments and/or shown in the figures alone can be used not only in the respectively stated combination, but also in other combinations. Embodiments of the invention which are not explicitly shown and explained in the figures but are clear and can be produced by means of separated combinations of features from the embodiments explained are therefore also included in or can be considered to be disclosed by the invention. The features, functions and/or effects described on the basis of the exemplary embodiments may each by themselves constitute individual features, functions and/or effects of the invention which can be considered independently of one another and each also develop the invention independently of one another. Therefore, the exemplary embodiments are also intended to comprise combinations other than those in the explained embodiments. In addition, the described embodiments may also be supplemented by further features, functions and/or effects of the invention from among those which have already been described.

### BRIEF DESCRIPTION OF THE DRAWINGS

In the figures, identical reference signs denote identical features and functions.

In the figures:

FIG. 1 shows a schematic circuit diagram illustration of an electrolysis device having a plurality of electrolytic cells which are connected in series and are connected to an electrolysis energy source and an auxiliary energy source connected in parallel therewith;

FIG. 2 shows a schematic diagram illustration of a bath characteristic curve for an electrolytic cell of the electrolysis device according to FIG. 1, in which a cell voltage of the electrolytic cell is represented on the basis of an electrolysis current of the electrolytic cell;

FIG. 3 shows a schematic circuit diagram illustration, like FIG. 1, of an electrolysis device in which two diodes connected in series can be respectively connected in parallel with each individual electrolytic cell by means of switching elements which are provided with electrical energy by an auxiliary voltage source;

FIG. 4 shows a schematic circuit diagram illustration, like FIG. 3, in which the diodes are replaced with in-phase regulators, and

FIG. 5 shows a schematic circuit diagram illustration, like FIG. 4, in which the in-phase regulators are connected to the auxiliary voltage source in a parallel connection.

### DETAILED DESCRIPTION OF INVENTION

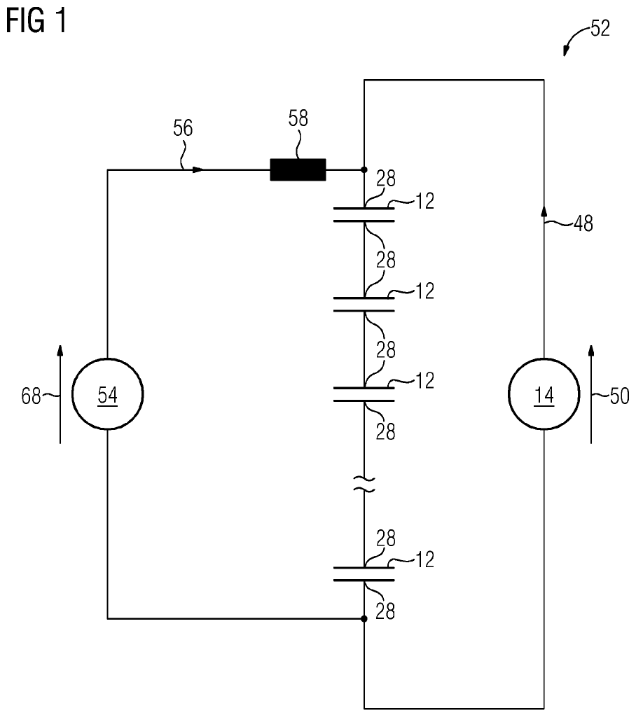

FIG. 1 shows a schematic circuit diagram illustration of an electrolysis device 52 having a plurality of electrolytic cells 12 electrically connected in series. The electrolytic cells 12 are used to electrolyze water to form hydrogen and oxygen. In alternative configurations, a different substance may naturally also be subjected to the electrolysis here in order to convert this substance into corresponding other substances.

The electrolytic cells 12 connected in series are connected to a main rectifier 14 as an electrolysis energy source. The main rectifier 14 provides an operating voltage 50 which is applied to the series circuit of the electrolytic cells 12, with the result that an electrolysis current 48 flows through the electrolytic cells 12 during intended electrolysis operation.

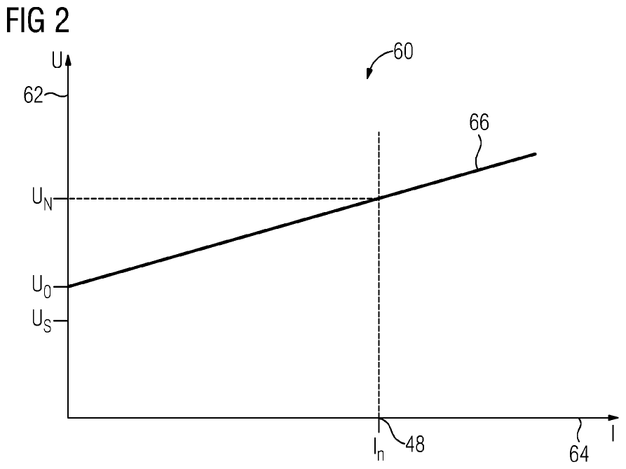

A series circuit comprising a polarization rectifier 54 and a protective inductance 58 is connected as an auxiliary energy source, in parallel with the main rectifier 14, to the series circuit of the electrolytic cells 12. The polarization rectifier 54 and the protective inductance 58 are used to apply a rectifier voltage 68 to the electrolytic cells 12 outside intended electrolysis operation, which rectifier voltage is selected in such a manner that a protective current 56 is established, which protective current is in turn selected such that at least a polarization voltage U₀ (FIG. 2) is applied to all electrolytic cells 12. This is intended to avoid undesirable processes in the electrolytic cells 12 outside intended electrolysis operation.

FIG. 2 shows a schematic diagram illustration of a diagram 60 in which an ordinate 62 is assigned to a cell voltage at respective cell connections 28 of an individual one of the electrolytic cells 12. An abscissa 64 is assigned to the corresponding cell current of this electrolytic cell 12. The dependence of the cell voltage on the cell current is represented using a graph 66. UN denotes an electrolysis voltage which is established at the electrolytic cell 12 during intended electrolysis operation if an electrolysis current 48 is applied to the electrolytic cell 12. A point of intersection of the graph 66 with the ordinate 62 defines the polarization voltage U₀ which, when undershot, can result in a change in the polarization of the cell current.

In the present configuration of an electrolytic cell for the electrolysis of water, the electrolysis voltage is approximately 1.8 to 1.9 V. In the present configuration, the polarization voltage U₀ may be approximately 1.48 V. In the case of a cell voltage which is greater than approximately 1.48 V, the electrolysis functionality begins at the electrolytic cell 12 by virtue of hydrogen and oxygen being produced.

The electrolysis device 52 proves to be disadvantageous insofar as gas production can still occur outside the actual electrolysis process or intended electrolysis operation. In this case, the result may be undefined states in the electrolysis device 52 which, in the worst case scenario, may even result in the production of an ignitable gas mixture. In order to ensure safety here, supplementary comprehensive protective measures are required.

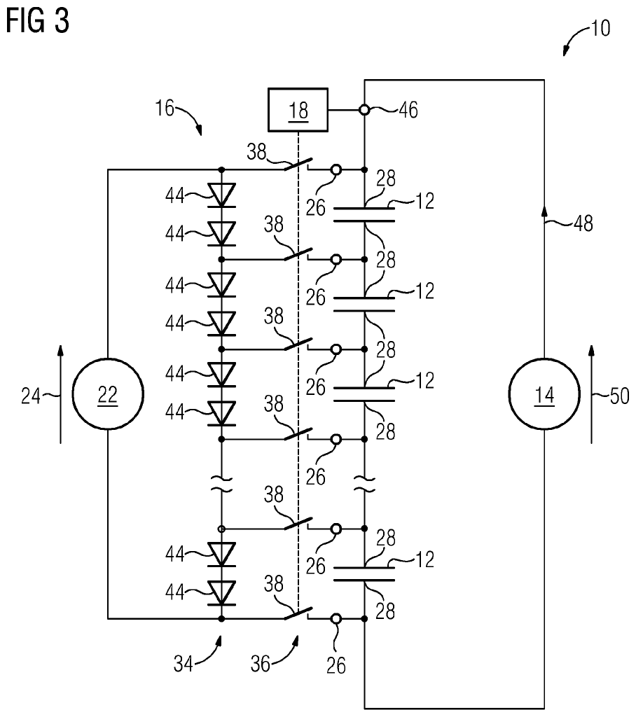

FIG. 3 now shows an electrolysis device 10 in which the above-mentioned problems can be reduced, if not even completely avoided. The electrolysis device 10 is based on the electrolysis device 52 according to FIG. 1, which is why reference is additionally made to the relevant statements. In this case too, a series circuit comprising a plurality of electrolytic cells 12 is provided and is connected to the main rectifier 14 in a parallel manner in order to be supplied with electrical energy during intended electrolysis operation. In this respect, the electrolysis device 10 corresponds to the electrolysis device 52, which is why reference is made to the corresponding statements relating to FIGS. 1 and 2.

In contrast to the configuration according to FIG. 1, provision is made for the electrolysis device 10 according to FIG. 3 to have an electrical auxiliary voltage source 22 which is used to provide an electrical auxiliary DC voltage 24. The electrolysis device 10 also has a circuit arrangement 16 which is connected to the electrolytic cells 12.

The circuit arrangement 16 has the electrical auxiliary voltage source 22 which is used to provide an electrical auxiliary DC voltage 24. The circuit arrangement 16 also comprises connection contacts 26 for electrical connection to cell connections 28 of the electrolytic cells 12 of the series circuit. In the present configuration, provision is therefore made for all cell connections 28 to also be electrically coupled to the circuit arrangement 16.

The circuit arrangement 16 also has a protective voltage unit 34 which is electrically coupled to the electrical auxiliary voltage source 22. The protective voltage unit 34 provides, for each of the electrolytic cells 12, an individual protective voltage Uₛ for the respective electrolytic cell 12.

The protective voltage Uₛ (FIG. 2) is selected in such a manner that a fuel cell effect is not produced at any of the electrolytic cells 12, that is to say residual gases in a respective electrolysis 12 react to form water and thus release energy according to the fuel cell principle. This may result in considerable aging of a respective electrolytic cell 12.

The circuit arrangement 16 also has a switching unit 36 which is connected to the protective voltage unit 34 and to the connection contacts 26. The switching unit 36 is designed to electrically couple the protective voltage unit 34 for providing the protective voltage Uₛ at the connection contacts 26 to the connection contacts 26 depending on a switching state of the switching unit 36. This makes it possible for the protective voltage unit 34 to need to be electrically connected to the electrolytic cells 12 only when this is necessary or desired on the basis of the operating situation of the electrolysis device 10. The protective voltage unit 34 can thus be deactivated with respect to the electrolytic cells 12 by means of the switching unit 36 if the electrolytic cells 12 are operated as intended in electrolysis operation.

The switching unit 36 therefore respectively has an individual switching element 38 for each of the connection contacts 26, which switching element is formed in the present case by a reed relay or reed contact. In alternative configurations, a corresponding relay or a contactor or an electronic switching element may naturally also be provided here.

The switching elements 38 are controlled together, in terms of their respective switching state, by a control unit 18 of the electrolysis device 10, with the result that all of the switching elements 38 each substantially assume the same switching state. For this purpose, the control unit 18 may comprise a control circuit which is also used, inter alia, to control the circuit arrangement 16.

In order to provide the protective voltage Uₛ, the protective voltage unit 34 has an electronic voltage converter which is coupled to the electrical auxiliary voltage source 22 and, in the present case, is formed by a series circuit of diodes 44. Two diodes 44 connected in series in a manner immediately following one another are respectively electrically connected to a respective one of the electrolytic cells 12 in the switched-on switching state of the switching unit 36.

In the present case, the diodes 44 are formed by silicon diodes. This makes it possible to easily individually provide the desired protective voltage for each of the electrolytic cells 12. The protective voltage Uₛ is less than the polarization voltage U₀. Therefore, the power which needs to be provided by the circuit arrangement 16 can be considerably reduced in comparison with the electrolysis device 52 according to FIG. 1. At the same time, as a result of the fact that only a very small, in particular negligible, electrical current needs to be conducted through the electrolytic cells 12, the unfavorable evolution of gas is also reduced in comparison with the electrolysis device 52, if not even completely avoided.

In order to control the switching unit 36, provision is made in the present configuration for the cell current of the series circuit of the electrolytic cells 12 to be captured by means of a current sensor 46 as a sensor unit. The current sensor 46 delivers a corresponding sensor signal to the control unit 18 which evaluates this signal. As soon as the sensor signal is smaller than a predefined comparison value, the switching unit 36 is changed over from the switched-off switching state to the switched-on switching state. This means that the corresponding protective voltage Uₛ is applied to each electrolytic cell 12 by the circuit arrangement 16 which is now activated as a result.

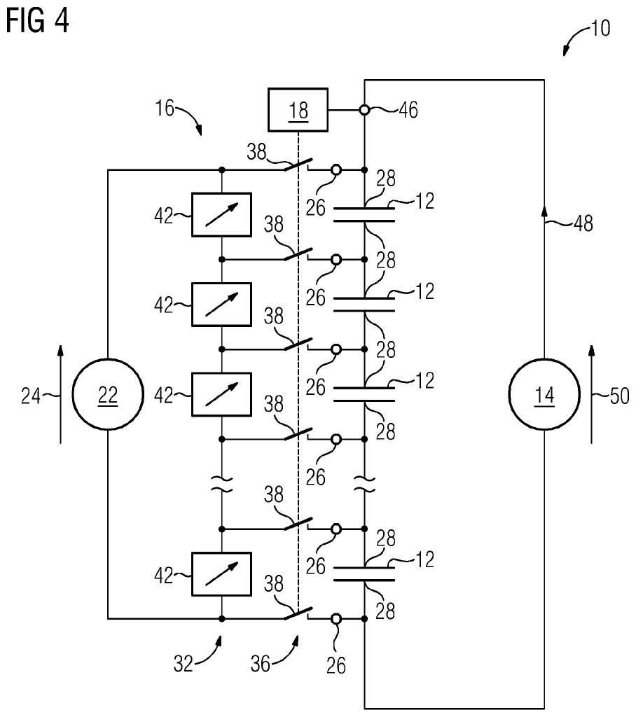

FIG. 4 shows a schematic circuit diagram illustration, like FIG. 3, of an alternative configuration of the electrolysis device 10. Only the differences from the configuration of the electrolysis device 10 according to FIG. 3 are explained below. The further features and functions correspond to those which have already been explained with respect to the electrolysis device 10 on the basis of FIG. 3.

In contrast to the configuration according to FIG. 3, the configuration according to FIG. 4 has a protective voltage unit 32 which has a voltage converter comprising in-phase regulators 42 connected in series. In the present case, the in-phase regulators 42 are adjustable and can be individually adjusted by the control unit 18 in terms of their respective protective voltage Uₛ. The in-phase regulators 42 can be adjusted manually during maintenance or activation of the electrolysis device 10 or in the form of regulation by individually capturing respective cell voltages or operating states of the electrolytic cells 12 and using them for regulation, for example. Like in the configuration according to FIG. 3, the auxiliary DC voltage 24 is applied to the series circuit of the in-phase regulators 42 by the auxiliary voltage source 22.

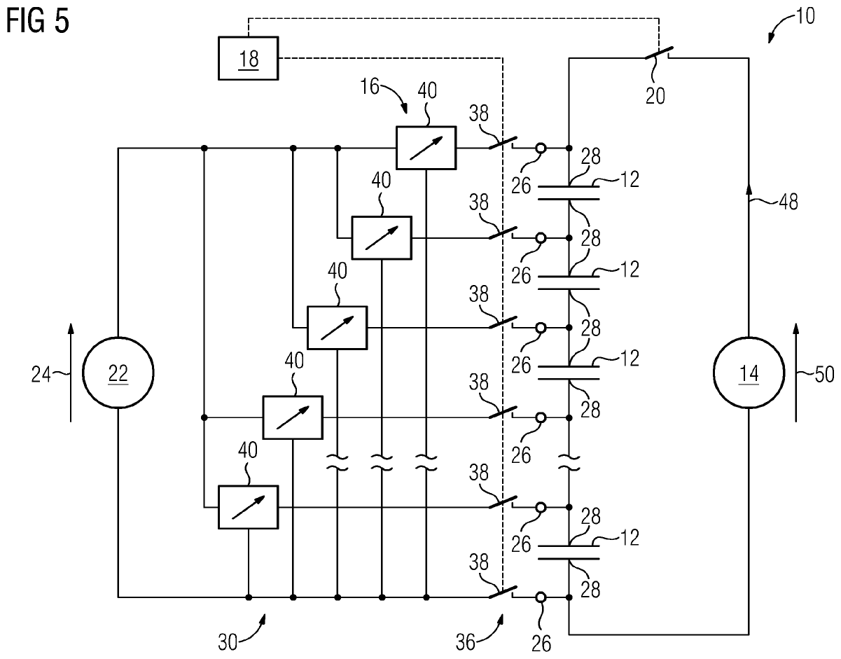

FIG. 5 shows a further configuration for an electrolysis device 10 which is likewise based on the configuration of the electrolysis device 10 according to FIG. 3, which is why reference is likewise additionally made to the relevant statements. Only the differences are explained further below.

It is clear from FIG. 5 that a protective voltage unit 30 is provided and has, for each electrolytic cell 12, a respective voltage converter 40 which can be adjusted by means of the control unit 18, as already explained on the basis of the configuration according to FIG. 4. In the present configuration, the voltage converters 40 are connected to the auxiliary voltage source 22 in a parallel manner and the auxiliary DC voltage 24 is applied to them by the auxiliary voltage source. The voltage converters 40 are adjusted in such a manner that the respective individual protective voltage Uₛ can be provided for each of the electrolytic cells 12.

In this configuration, provision is made for the voltage converters 40 to be formed by a clocked voltage converter in the form of a DC/DC converter. In alternative configurations, an in-phase regulator, like the in-phase regulator 42 according to FIG. 4, may naturally likewise also be provided here.

In addition, provision is made in the present case for the main rectifier 14 to be able to be electrically isolated from the electrolytic cells 12 via an isolating unit 20 which is in the form of a contactor in the present case. This is advantageous if the main rectifier 14 has a fault which may result, for example, in a short circuit or the like. If the electrolysis device 10 is not in intended electrolysis operation, the isolating unit 20 may be switched to the switched-off state by means of the control unit 18, with the result that the main rectifier 14 is electrically isolated from the electrolytic cells 12. In a particularly advantageous manner, locking may be provided by means of the control unit 18 in such a manner that either only the switching unit 36 or the isolating unit 20 is in the switched-on switching state.

The exemplary embodiments are used solely to explain the invention and are not intended to restrict the latter.

1. A circuit arrangement for at least one electrolytic cell of an electrolysis device, comprising:
an electrical auxiliary voltage source which is designed to provide an electrical auxiliary DC voltage,
connection contacts for electrical connection to cell connections of the at least one electrolytic cell,
a protective voltage unit which is electrically coupled to the electrical auxiliary voltage source and is designed to provide an individual protective voltage for the at least one electrolytic cell, and
a switching unit which is connected to the protective voltage unit and to the connection contacts and is designed to electrically couple the protective voltage unit for providing the protective voltage at the connection contacts to the connection contacts depending on a switching state of the switching unit.

2. The circuit arrangement as claimed in claim 1,
wherein the switching unit comprises at least one individual switching element for each of the connection contacts.

3. The circuit arrangement as claimed in claim 1,
wherein the protective voltage unit for providing the protective voltage comprises an electronic voltage converter electrically connected to the electrical auxiliary voltage source.

4. The circuit arrangement as claimed in claim 3,
wherein the voltage converter is in the form of an in-phase regulator.

5. The circuit arrangement as claimed in claim 3,
wherein the voltage converter has at least one diode and/or at least one electrical resistor which is used to provide the protective voltage.

6. The circuit arrangement as claimed in claim 1, further comprising:
a sensor unit which is connected at least to the switching unit and is designed to capture an electrolysis current of the at least one electrolytic cell and to transmit a corresponding sensor signal at least to the switching unit.

7. An electrolysis device, comprising:
at least one electrolytic cell and an electrolysis energy source connected to the at least one electrolytic cell, and
a circuit arrangement as claimed in claim 1, which is connected to the at least one electrolytic cell.

8. The electrolysis device as claimed in claim 7, further comprising:
a control unit which is designed to capture an operating state of the electrolysis energy source and to transmit a state signal to the circuit arrangement depending on the captured operating state, wherein the circuit arrangement is designed to provide a protective voltage for the at least one electrolytic cell depending on the state signal.

9. The electrolysis device as claimed in claim 7, further comprising:
an isolating unit which is designed to electrically isolate the electrolysis energy source from the at least one electrolytic cell depending on a switching state of the isolating unit.

10. A method for operating an electrolysis device, comprising:
applying an electrical electrolysis current to at least one electrolytic cell of the electrolysis device during intended operation in order to electrolyze a substance arranged in a reaction chamber of the electrolytic cell,
capturing the electrical electrolysis current by a sensor unit, and
applying a protective voltage, which is individually provided for the at least one electrolytic cell, to the at least one electrolytic cell depending on the captured electrical electrolysis current.
